(19) United States
(12) Patent Application Publication
(10) Pub. No.: US 2025/0079569 A1
(43) Pub. Date: Mar. 6, 2025

(54) BATTERY MODULE COOLING STRUCTURE

(71) Applicants: Hyundai Motor Company, Seoul (KR); Kia Corporation, Seoul (KR)

(72) Inventors: Jiwoong Jung, Anyang-si (KR); Hyunchang Kang, Seoul (KR); Junyoung Kang, Hwaseong-si (KR)

(21) Appl. No.: 18/671,310

(22) Filed: May 22, 2024

(30) Foreign Application Priority Data
Sep. 1, 2023 (KR) 10-2023-0116279

(51) Int. Cl. H01M 10/6568; H01M 10/42; H01M 10/613; H01M 10/6556; H01M 50/258; H01M 50/264

(52) U.S. Cl. CPC H01M 10/6568; H01M 10/425; H01M 10/613; H01M 10/6556; H01M 50/258; H01M 50/264

(57) ABSTRACT

An embodiment battery module cooling structure includes a plurality of battery cells assembled together, a plurality of cartridges configured to fix edge portions of the plurality of battery cells so that the plurality of battery cells is aligned and accommodated in the plurality of cartridges, the plurality of cartridges being configured such that a cooling liquid is introduced into and discharged from the plurality of cartridges, and a plurality of cooling channels disposed between the plurality of battery cells and configured to guide the cooling liquid introduced into the plurality of cartridges so that the cooling liquid flows in one direction of the plurality of battery cells.

### CROSS-REFERENCE TO RELATED APPLICATIONS

This application claims the benefit of Korean Patent Application No. 10-2023-0116279, filed on Sep. 1, 2023, which application is hereby incorporated herein by reference.

### TECHNICAL FIELD

The present disclosure relates to a battery module cooling structure.

### BACKGROUND

In general, a battery pack for an environmentally friendly vehicle includes battery modules made by assembling a plurality of battery cells. The battery pack finally mounted in the vehicle is manufactured by assembling a plurality of battery modules.

A pouch cell-based battery module broadly includes battery cells, surface pressure pads, endplates, sensing boards, and the like. The battery module requires advanced battery cell cooling technologies to meet the high specifications related to the high performance and fast charging performance of batteries. An immersion cooling technology, which is a direct cooling technology, may be considered to improve the cooling performance. The components used for the immersion cooling method include basic components of the battery module, a module housing, a cooling channel, and a cooling liquid (dielectric thermal fluid) for direct cooling.

In this case, in order to cool inner battery cells, cooling channels may be disposed between the battery cells, and the direct cooling may be implemented by a flow of the cooling liquid. In the case of a general battery cell module, a sensing board is provided on a flow path through which the cooling liquid is introduced or discharged, and the presence of the sensing board hinders the flow of cooling liquid through the cooling channel between the battery cells, which may degrade the cooling efficiency.

### SUMMARY

The present disclosure relates to a battery module cooling structure. Particular embodiments relate to a structure for guiding a flow of a cooling liquid in an immersion cooling battery module, the structure having a cooling channel provided between battery cells to allow a cooling liquid to flow in a battery module.

Embodiments of the present disclosure provide a battery module cooling structure in which a cooling channel is provided between battery cells in a cartridge and guides a flow of a cooling liquid to improve cooling performance efficiency, and a protrusion structure is provided in the cartridge to improve stability at the time of aligning and fixing the battery cells.

A battery module cooling structure according to an embodiment of the present disclosure is configured by assembling a plurality of battery cells and includes a plurality of cartridges configured to fix edge portions of the plurality of battery cells so that the plurality of battery cells is aligned and accommodated, the plurality of cartridges being configured such that a cooling liquid is introduced into and discharged from the plurality of cartridges, and a plurality of cooling channels disposed between the plurality of battery cells and configured to guide the cooling liquid introduced into the cartridges so that the cooling liquid flows in one direction of the battery cell.

An inlet port may be provided at an upper end of one side of the cartridge so that the cooling liquid is introduced into the cartridge from the outside through the inlet port, and an outlet port may be provided at a lower end of the other side of the cartridge so that the cooling liquid introduced into the cartridge is discharged to the outside through the outlet port.

The inlet port and the outlet port may be connected to cooling liquid flow paths extending in a longitudinal direction of the cartridge at upper and lower ends of the cartridge.

Protrusion portions for fixing upper ends of the battery cells may be formed at an inner side of the upper end of the cartridge, and the protrusion portions may be in contact with the upper ends of the pair of battery cells facing each other.

The cooling liquid flow path may be formed between the protrusion portions.

The cooling liquid flow path may communicate with the cooling channel, and the cooling liquid flowing through the cooling liquid flow path may flow in one direction of the battery cell through the cooling channel.

Surface pressure pads may be attached to outer surfaces of the pair of battery cells facing each other with the cooling channel interposed therebetween.

An endplate, which defines an outermost periphery of the battery module, may be attached to an outer surface of the surface pressure pad disposed at the outermost periphery among the surface pressure pads.

The plurality of cartridges may be coupled to one another by coupling parts formed at upper ends of the cartridges.

The coupling parts may be connected by being fitted with each other by male-female coupling.

The cooling channel may be aligned by being attached to a surface of the battery cell by a bonding agent.

One end of the cartridge and one end of the endplate may be fastened by a sensing board.

According to an embodiment of the present disclosure, the battery module cooling structure includes the cooling channel configured to guide the flow of the cooling liquid between the battery cells in the cartridge, such that the cooling liquid may be introduced, flows, and is discharged along the optimal route between the battery cells, thereby maximizing the cooling performance efficiency.

In addition, the protrusion portions for fixing the upper ends of the battery cells may be formed on the inner side of the upper end of the cartridge, thereby aligning the battery cells and ensuring the structural stability at the time of configuring the battery module.

### BRIEF DESCRIPTION OF THE DRAWINGS

FIG. 1 is a perspective view illustrating a battery module cooling structure according to an embodiment of the present disclosure.

FIG. 2 is an exploded perspective view illustrating a part of the battery module cooling structure according to an embodiment of the present disclosure.

FIG. 3 is a view schematically illustrating a flow of a cooling liquid in the battery module cooling structure according to an embodiment of the present disclosure.

FIG. 4 is a view schematically illustrating a flow of the cooling liquid introduced into an inlet port in the battery module cooling structure according to an embodiment of the present disclosure.

FIG. 5 is a view schematically illustrating a flow of the cooling liquid discharged to an outlet port in the battery module cooling structure according to an embodiment of the present disclosure.

FIG. 6 is a cross-sectional view illustrating a portion where a cartridge and a battery cell are coupled in the battery module cooling structure according to an embodiment of the present disclosure.

FIG. 7 is a view illustrating a connection structure between the cartridges in the battery module cooling structure according to an embodiment of the present disclosure.

### DETAILED DESCRIPTION OF ILLUSTRATIVE EMBODIMENTS

Hereinafter, embodiments of the present disclosure will be described in detail with reference to the accompanying drawings so that those with ordinary skill in the art to which the present disclosure pertains may easily carry out the embodiments. The present disclosure may be implemented in various different ways and is not limited to the embodiments described herein.

In addition, the constituent elements having the same configurations in several embodiments will be assigned with the same reference numerals and described only in the representative embodiment, and only the constituent elements, which are different from the constituent elements according to the representative embodiment, will be described in other embodiments.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements, or components illustrated in two or more drawings in order to exhibit similar characteristics. When one component is described as being positioned “above” or “on” another component, one component can be positioned “directly on” another component, and one component can also be positioned on another component with other components interposed therebetween.

The embodiments of the present disclosure specifically illustrate examples of the present disclosure. As a result, various modifications of the drawings are expected. Therefore, the embodiments are not limited to specific forms in regions illustrated in the drawings, and for example, include modifications of forms by the manufacture thereof.

Hereinafter, a battery module cooling structure according to an embodiment of the present disclosure will be described in detail with reference to the accompanying drawings.

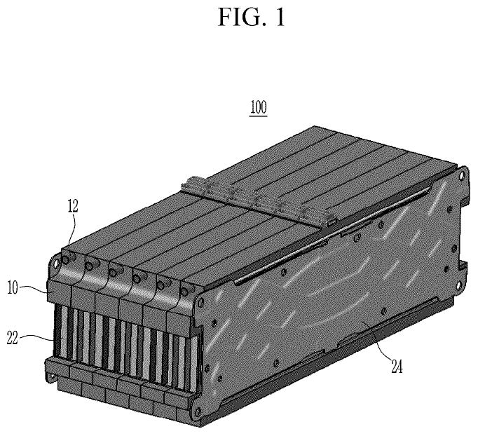

FIG. 1 is a perspective view illustrating a battery module cooling structure according to an embodiment of the present disclosure.

With reference to FIG. 1, a battery module cooling structure 100 according to an embodiment of the present disclosure includes a plurality of cartridges 10 and a plurality of cooling channels 15.

A plurality of battery cells 20 may be aligned and accommodated in the plurality of cartridges 10. Two battery cells 20 may be accommodated in each of the cartridges 10. The cartridge 10 may fix an edge portion of the battery cell 20, and a cooling liquid may be introduced into or discharged from the cartridge 10. The cooling liquid may be configured as a coolant.

An inlet port 12, through which the cooling liquid is introduced into the cartridge 10 from the outside, may be provided at an upper end of one side of the cartridge 10, and an outlet port 14, through which the cooling liquid introduced into the cartridge 10 is discharged to the outside, may be provided at a lower end of the other side of the cartridge 10. That is, the cooling liquid, which is introduced to an upper side in the cartridge 10 through the inlet port 12, eliminates heat generated in the battery cell 20 while flowing around the battery cell 20 in the cartridge 10. The cooling liquid is discharged to the outside of the cartridge 10 through the outlet port 14.

The plurality of cooling channels 15 is disposed between the plurality of battery cells 20 and guides the cooling liquid introduced into the cartridge 10 so that the cooling liquid flows in one direction of the battery cell 20.

Meanwhile, the plurality of cartridges 10 is coupled to one another by coupling parts 30 provided at upper ends of the cartridge 10, and the plurality of cartridges 10 is aligned side by side. Endplates 24 are attached to outer surfaces of the outermost peripheral cartridges 10 among the plurality of cartridges 10 and define outermost peripheries of the battery module. In addition, one end of the cartridge 10 and one end of the endplate 24 are fastened by a sensing board 22.

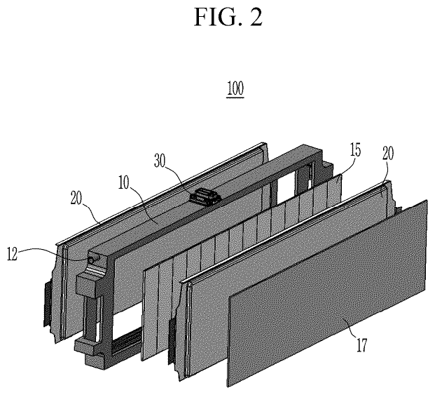

FIG. 2 is an exploded perspective view illustrating a part of the battery module cooling structure according to an embodiment of the present disclosure.

With reference to FIG. 2, the battery module cooling structure 100 includes the cartridge 10, the battery cells 20 aligned and accommodated in the cartridge 10, a cooling channel 15 disposed between the battery cells 20, and a surface pressure pad 17 attached to an outer surface of the battery cell 20.

As illustrated in FIG. 2, one cartridge 10 fixes edge portions of the two battery cells 20, such that the battery cells 20 are aligned. One cooling channel 15 between the two battery cells 20 may be attached to the surface of the battery cell 20.

The cooling channel 15 may be attached to an inner surface of one of the two battery cells 20 by a bonding agent such as a hot-melt adhesive. A plurality of grooves may be formed in the cooling channel 15 and disposed side by side in a direction perpendicular to a longitudinal direction of the cartridge 10. The cooling liquid may flow through the grooves.

In addition, the surface pressure pad 17 may be attached to the outer surface of any one of the two battery cells 20. The surface pressure pad 17 may fix the plurality of battery cells 20 and mitigate an impact applied to the battery cell 20.

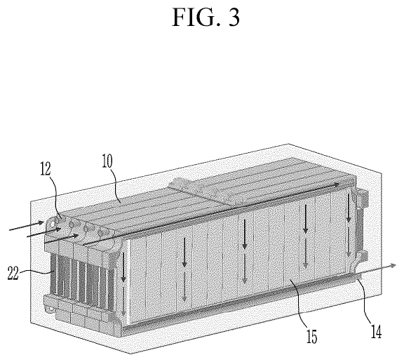

FIG. 3 is a view schematically illustrating a flow of the cooling liquid in the battery module cooling structure according to an embodiment of the present disclosure.

With reference to FIG. 3, the cooling liquid is introduced into the cartridge 10 from the outside through the inlet port 12 provided at the upper end of one side of each of the plurality of cartridges 10. The inlet port 12 is connected to a cooling liquid flow path 18 extending in the longitudinal direction of the cartridge 10 at an upper end of the cartridge 10. The cooling liquid is introduced into the inlet port 12 and flows along the cooling liquid flow path 18. Likewise, the outlet port 14 is connected to a cooling liquid flow path 18 extending in the longitudinal direction of the cartridge 10 at a lower end of the cartridge 10, and the cooling liquid is discharged to the outside through the outlet port 14 from the cooling liquid flow path 18.

The cooling liquid flow path 18 connected to the inlet port 12 communicates with the cooling channel 15 disposed between the battery cells 20, and the cooling liquid flowing along the cooling liquid flow path 18 flows through the cooling channel 15 in one direction of the battery cell 20, i.e., the direction perpendicular to the longitudinal direction of the cartridge 10.

The cooling liquid flow path 18 connected to the outlet port 14 also communicates with the cooling channel 15, and the cooling liquid flowing through the cooling channel 15 flows along the cooling liquid flow path 18 and is discharged to the outside through the outlet port 14.

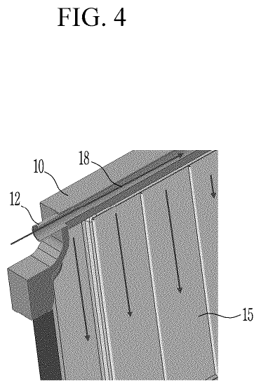

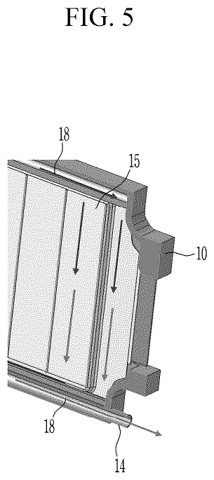

FIG. 4 is a view schematically illustrating a flow of the cooling liquid introduced into an inlet port in the battery module cooling structure according to an embodiment of the present disclosure, and FIG. 5 is a view schematically illustrating a flow of the cooling liquid discharged to an outlet port in the battery module cooling structure according to an embodiment of the present disclosure.

The cooling liquid flow path 18 connected to the inlet port 12 has an opening entirely formed in the longitudinal direction of the cartridge 10, and the opening communicates with the cooling channel 15. Therefore, a part of the cooling liquid, which is introduced into the inlet port 12 and flows to the cooling liquid flow path 18, may sequentially flow downward from a left side of the cooling channel 15 and be uniformly distributed to the cooling channel 15.

In addition, the cooling liquid flow path 18 connected to the outlet port 14 also has an opening entirely formed in the longitudinal direction of the cartridge 10, and the opening communicates with the cooling channel 15. The cooling liquid flowing along the cooling channel 15 flows along the cooling liquid flow path 18 and is discharged to the outside through the outlet port 14.

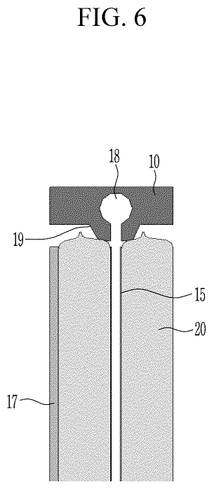

FIG. 6 is a cross-sectional view illustrating a portion where the cartridge and the battery cell are coupled in the battery module cooling structure according to an embodiment of the present disclosure.

With reference to FIG. 6, protrusion portions 19 are formed at an inner side of the upper end of the cartridge 10. The protrusion portions 19 may protrude downward from the upper end of the cartridge 10 at two opposite sides of the cooling liquid flow path 18. That is, the cooling liquid flow path 18 may be formed between the protrusion portions 19. Lower ends of the protrusion portions 19 are in contact with upper ends of the pair of battery cells 20 facing each other, such that the battery cells 20 may be fixed to the cartridge 10.

In addition, the cooling liquid flow path 18 communicates with the cooling channel 15 provided between the battery cells 20. The cooling liquid flowing along the cooling liquid flow path 18 flows downward along the cooling channel 15 and cools the battery cell 20.

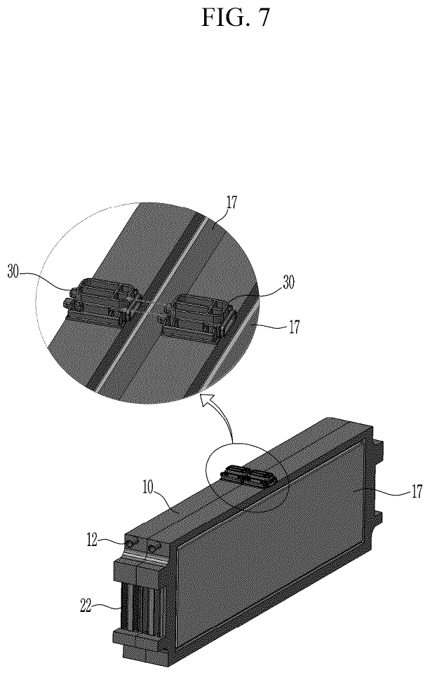

FIG. 7 is a view illustrating a connection structure between the cartridges in the battery module cooling structure according to an embodiment of the present disclosure.

With reference to FIG. 7, the plurality of cartridges 10 is coupled to one another by the coupling parts 30 provided at the upper ends of the cartridges 10. The coupling part 30 may be connected by being fitted with each other by male-female coupling. For example, one side of the coupling part 30 may be formed as a male connector, and the other side of the coupling part 30 may be formed as a female connector. The male connector of the coupling part 30 formed on a first cartridge 10 may be fitted with the female connector of the coupling part 30 formed on a second cartridge 10 adjacent to the first cartridge 10.

As described above, according to an embodiment of the present disclosure, the battery module cooling structure includes the cooling channel configured to guide the flow of the cooling liquid between the battery cells in the cartridge, such that the cooling liquid may be introduced, flows, and is discharged along the optimal route between the battery cells, thereby maximizing the cooling performance efficiency.

In addition, the protrusion portions for fixing the upper ends of the battery cells may be formed on the inner side of the upper end of the cartridge, thereby aligning the battery cells and ensuring the structural stability at the time of configuring the battery module.

While the exemplary embodiments of the present disclosure have been described, the present disclosure is not limited to the embodiments. The present disclosure covers all modifications that can be easily made from the embodiments of the present disclosure by those skilled in the art and considered as being equivalent to the present disclosure.

What is claimed is:

1. A battery module cooling structure comprising:
a plurality of battery cells assembled together;
a plurality of cartridges configured to fix edge portions of the plurality of battery cells so that the plurality of battery cells is aligned and accommodated in the plurality of cartridges, the plurality of cartridges being configured such that a cooling liquid is introduced into and discharged from the plurality of cartridges; and
a plurality of cooling channels disposed between the plurality of battery cells and configured to guide the cooling liquid introduced into the plurality of cartridges so that the cooling liquid flows in one direction of the plurality of battery cells.

2. The battery module cooling structure of claim 1, further comprising:
an inlet port disposed at an upper end of a first side of each cartridge of the plurality of cartridges, wherein the inlet port is configured to introduce the cooling liquid into the respective cartridge from an outside; and
an outlet port disposed at a lower end of a second side of each cartridge of the plurality of cartridges, wherein the outlet port is configured to discharge the cooling liquid introduced into the respective cartridge to the outside.

3. The battery module cooling structure of claim 2, wherein the inlet port and the outlet port are connected to cooling liquid flow paths extending in a longitudinal direction of the respective cartridge at the upper end and the lower end of the respective cartridge.

4. The battery module cooling structure of claim 3, further comprising protrusion portions disposed at an inner side of the upper end of the respective cartridge, the protrusion portions being configured to fix upper ends of the battery cells.

5. The battery module cooling structure of claim 4, wherein the protrusion portions are in contact with the upper ends of a pair of the battery cells facing each other.

6. The battery module cooling structure of claim 5, wherein the cooling liquid flow path at the upper end of the cartridge is defined between the protrusion portions.

7. The battery module cooling structure of claim 6, wherein:
the cooling liquid flow paths communicate with the cooling channels; and
the cooling liquid flowing through the cooling liquid flow path at the upper end of the cartridge flows in the one direction of the plurality of battery cells through the cooling channel of the respective cartridge.

8. The battery module cooling structure of claim 1, wherein the cartridges of the plurality of cartridges are coupled to one another by coupling parts disposed at upper ends of the plurality of cartridges.

9. The battery module cooling structure of claim 8, wherein the coupling parts are connected by being fitted with each other by male-female coupling.

10. The battery module cooling structure of claim 1, wherein the plurality of cooling channels is aligned along a surface of the plurality of battery cells.

11. A battery module cooling structure comprising:
a plurality of battery cells assembled together;
a plurality of cartridges configured to fix edge portions of the plurality of battery cells so that the plurality of battery cells is aligned and accommodated in the plurality of cartridges, the plurality of cartridges being configured such that a cooling liquid is introduced into and discharged from the plurality of cartridges;
a plurality of cooling channels disposed between the plurality of battery cells and configured to guide the cooling liquid introduced into the plurality of cartridges so that the cooling liquid flows in one direction of the plurality of battery cells; and
surface pressure pads attached to outer surfaces of a pair of the battery cells facing each other with a cooling channel of the plurality of cooling channels interposed therebetween.

12. The battery module cooling structure of claim 11, further comprising an endplate that defines an outermost periphery of a battery module, the endplate being attached to an outer surface of the surface pressure pad disposed at the outermost periphery among the surface pressure pads.

13. The battery module cooling structure of claim 12, wherein one end of the plurality of cartridges and one end of the endplate are fastened by a sensing board.

14. The battery module cooling structure of claim 11, wherein the plurality of cooling channels is aligned along a surface of the plurality of battery cells.

15. A battery module cooling structure comprising:
cartridges aligned side by side and coupled to one another by coupling parts, each cartridge being configured to fix edge portions of a pair of battery cells facing each other such that the pair of battery cells is aligned and accommodated in the cartridge, and each cartridge being configured to receive a cooling liquid introduced thereinto and to discharge the cooling liquid therefrom; and
a plurality of cooling channels, wherein a cooling channel of the plurality of cooling channels is disposed between each pair of battery cells in each cartridge, and wherein each cooling channel is configured to guide the cooling liquid introduced into the cartridge to flow in one direction of the pair of battery cells.

16. The battery module cooling structure of claim 15, wherein each cartridge comprises:
an inlet port disposed at an upper end of a first side of the cartridge, wherein the inlet port is configured to receive the cooling liquid from an outside and introduce the cooling liquid into the cartridge; and
an outlet port disposed at a lower end of a second side of the cartridge, wherein the outlet port is configured to discharge the cooling liquid introduced into the cartridge to the outside.

17. The battery module cooling structure of claim 16, wherein each cartridge further comprises cooling liquid flow paths extending in a longitudinal direction of the cartridge at the upper end and the lower end of the cartridge, and wherein the inlet port and the outlet port are connected to the cooling liquid flow paths.

18. The battery module cooling structure of claim 15, further comprising endplates attached to outer surfaces of outermost peripheral cartridges of the cartridges.

19. The battery module cooling structure of claim 18, further comprising a sensing board, wherein one end of the endplates and one end of the cartridges are fastened by the sensing board.

20. The battery module cooling structure of claim 15, further comprising protrusion portions respectively disposed at an inner side of an upper end of each cartridge, the protrusion portions being configured to fix upper ends of the pair of battery cells in the cartridge, wherein a cooling liquid flow path is defined between the protrusion portions.
